(19) United States
(12) Patent Application Publication
(10) Pub. No.: US 2009/0051414 A1
(43) Pub. Date: Feb. 26, 2009

(54) Dual conversion rate voltage booster apparatus and method

(76) Inventor: Per Olaf Pahr, Lier (NO)

Correspondence Address: DICKSTEIN SHAPIRO LLP, 1825 EYE STREET NW, Washington, DC, 20006-5403, US

(21) Appl. No.: 11/892,111

(22) Filed: Aug. 20, 2007

(51) Int. Cl. G05F 3/02; H02J 1/00

(52) U.S. Cl. 327/536; 307/81

(57) ABSTRACT

An apparatus and method of boosting voltages. A boosting circuit includes a first and a second boosting circuit that each provide a boosted voltage in response to a set of control signals. The first and second boosting circuits receive different sets of control signals so that the boosted voltages may be alternately transferred to and combined at a load terminal.

### FIELD OF THE INVENTION

The embodiments disclosed herein relate generally to voltage booster circuits and more specifically to high frequency voltage booster circuits.

### BACKGROUND OF THE INVENTION

A voltage booster circuit is designed to generate a voltage that is greater than one or more voltages input to the booster circuit. Voltage booster circuits are used in memory and imaging devices as well as other semiconductor integrated circuits where there is a need to internally generate voltages that are greater than an external or off-chip power supply potential. For example, in many memory devices, a first voltage may be required in order to read a memory cell, and a second, greater voltage may be required in order to program or write the memory cell. Voltage booster circuits are often used to boost the input first voltage to the required second voltage. Similarly, in imaging devices, there is often a need to provide boosted voltages to various transistor gates associated with each pixel in order to overcome various inconsistencies in transistor threshold voltages. In an imaging device, voltage booster circuits may be used to boost signals supplied to reset, transfer and row-select transistors as well as to facilitate photogate charge storing and charge transfer. Many other uses of a voltage booster circuit are possible.

High-frequency voltage boosting is very desirable. As customers continue to demand increased speed in products such as imaging and memory devices, the operating frequencies of these devices are increased. Hence, any necessary or desired voltage boosting must also be performed at a higher frequency. There is a continual need to improve existing voltage boosting circuits to meet the demands of high-frequency operation (e.g., from 10 MHz to around 20 MHz).

### BRIEF DESCRIPTION OF THE DRAWINGS

FIG. 1 is a schematic of a previously used three-phase voltage booster circuit.

FIG. 2 is a schematic of a previously used switch control signal circuit for the three-phase voltage booster circuit of FIG. 1.

FIG. 3 is a timing diagram for the switch control signal circuit of FIG. 2.

FIG. 4 is a schematic of a six-phase voltage booster circuit according to a disclosed embodiment.

FIGS. 5A and 5B are schematics of switch control signal circuits for the six-phase voltage booster circuit of FIG. 4 according to a disclosed embodiment.

FIG. 6 is a timing diagram for the switch control signal circuits of FIGS. 5A and 5B according to a disclosed embodiment.

FIG. 7 is a simplified block diagram of an imager according to a disclosed embodiment.

FIG. 8 is a simplified block diagram of a processing system according to a disclosed embodiment.

### DETAILED DESCRIPTION OF THE INVENTION

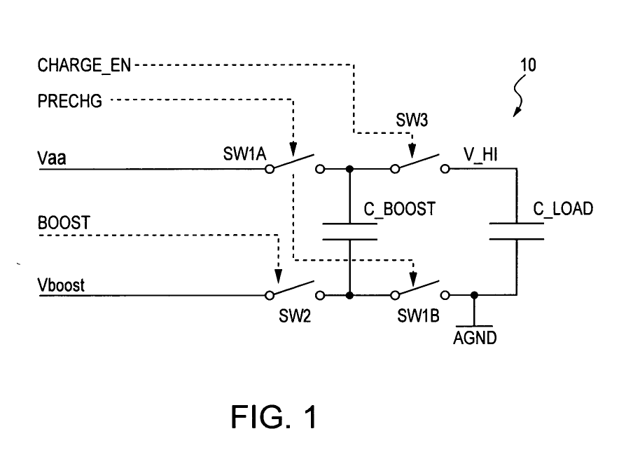

FIG. 1 is an example of a previously used three-phase voltage booster circuit 10. The circuit 10 is capable of generating an output voltage V_hi that is greater than either of the input voltages Vaa, Vboost. The maximum output voltage V_hi is approximately equal to the sum of the input voltages Vaa, Vboost. This “boosting” of the input voltage Vaa is achieved by using a three-phase cycle of precharging, boosting and transferring of collected charge, as is explained in detail below.

The circuit 10 of FIG. 1 has three switch control signals, namely, charge_en, boost, and prechg. The first switch control signal charge_en controls the opening and closing of switch sw3. The third switch control signal prechg controls the opening and closing of switches sw1a, sw1b. The second switch control signal boost controls the opening and closing of switch sw2. When the switch control signals charge_en, boost, and prechg are all high, the controlled switches sw3, sw2, sw1a, sw1b, respectively, are closed. When the switch control signals charge_en, boost, prechg are all low, the controlled switches sw3, sw2, sw1a, sw1b, respectively, are open. The closing and opening of the switches sw3, sw2, sw1a, sw1b at precise times is crucial to the successful operation of the circuit 10. Furthermore, as operating frequencies increase, the importance of the switch control signal timings also increases.

The circuit 10 of FIG. 1 is capable of being in one of three operating modes which are an idle mode, a three-phase charge generation or boost mode, and a charge-conserving hold mode. When the booster circuit 10 is in an idle mode, switches sw1a, sw1b, sw3 are closed while switch sw2 is open. Thus, during the idle mode, a load capacitor C_load is charged to the input voltage supply Vaa. In the boost mode, voltage boosting begins when switches sw3, sw1a, sw1b are opened and switch sw2 is closed. The closing of switch sw2 couples the boost voltage Vboost to the back-plate of capacitor C_boost. As a result, the voltage on capacitor C_boost is “lifted up,” meaning that the voltage on the front-plate of capacitor C_boost is raised. When switch sw3 is closed, charge from capacitor C_boost is transferred to capacitor C_load. After the charge transfer, switch sw3 is opened. Switch sw2 is then opened and capacitor C_boost charging is again initiated by closing switches sw1a, sw1b. This three-phase cycle of precharging, boosting, and transferring is repeated as many times as is required for the output voltage V_hi to be boosted to a desired value or, alternatively, the maximum value (i.e., the sum of voltage supply Vaa and boost voltage Vboost). Once the output voltage V_hi is at the desired or maximum value, the circuit 10 is maintained in a “hold” mode while the output voltage V_hi is sampled. The hold mode is implemented by interrupting the three-phase boost mode during the boost phase and holding the circuit 10 in the boost phase by keeping switch sw3 closed while switches sw1a, sw1b are left open.

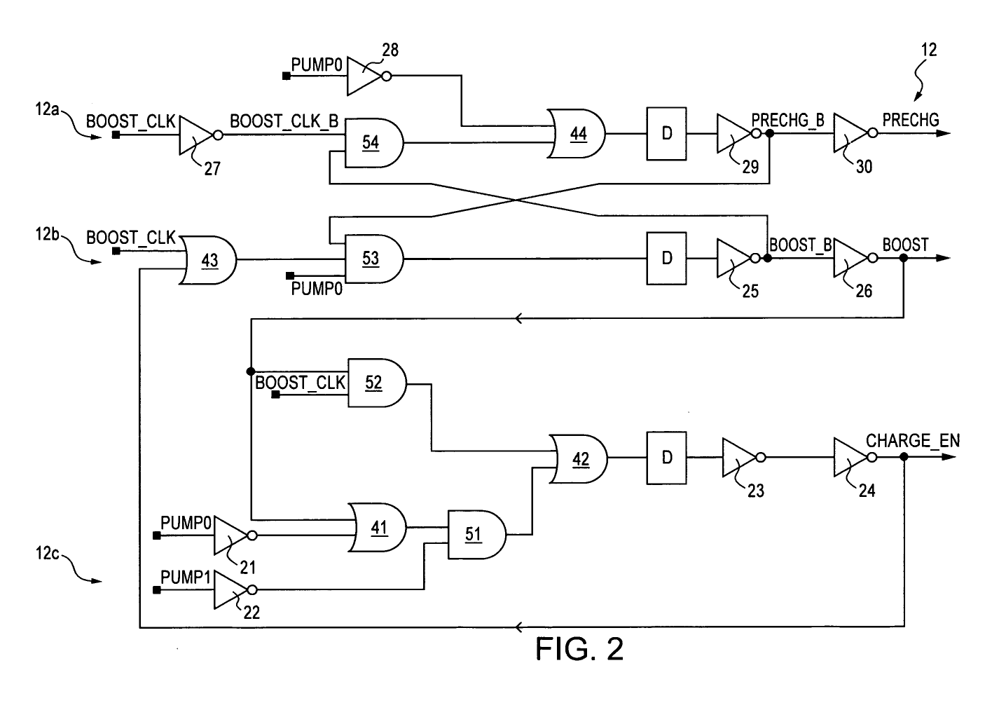

The switch control signals charge_en, prechg, boost can be generated by a switch control signal circuit 12, as illustrated in FIG. 2. The switch control signal circuit 12 includes an input for a clock signal boost_clk and two control signal inputs for control signals pump0, pump1. The clock signal boost_clk oscillates between a high state and a low state at a predetermined frequency. The control signals pump0, pump1 may each be in either a high state or a low state, the combination of states resulting in the switch control signals charge_en, prechg, boost triggering either an idle, boost or hold state of the circuit 10. For example, and as described in greater detail below, when control signals pump0, pump1 are both low, the switch control signals charge_en, prechg, boost output from the control circuit 12 have values that place circuit 10 in an idle state. In other words, when control signals pump0, pump1 are low, switch control signals charge_en, prechg are high and switch control signal boost is low, meaning that switches sw1a, sw1b, sw3 are closed and switch sw2 is open. When control signals pump0, pump1 are both high, the circuit 10 is placed in a boost state, meaning that the circuit 10 repeatedly cycles through the three-phases of precharge, boost and transfer, resulting in the output voltage V_hi being raised to the desired level. When control signal pump0 is high and control signal pump1 is low, the circuit 10 is maintained in the hold state (i.e., switches sw1a, sw1b are open and switch sw3 is closed; switch sw2 is also closed though this is not necessary for the circuit 10 to be maintained in a hold state).

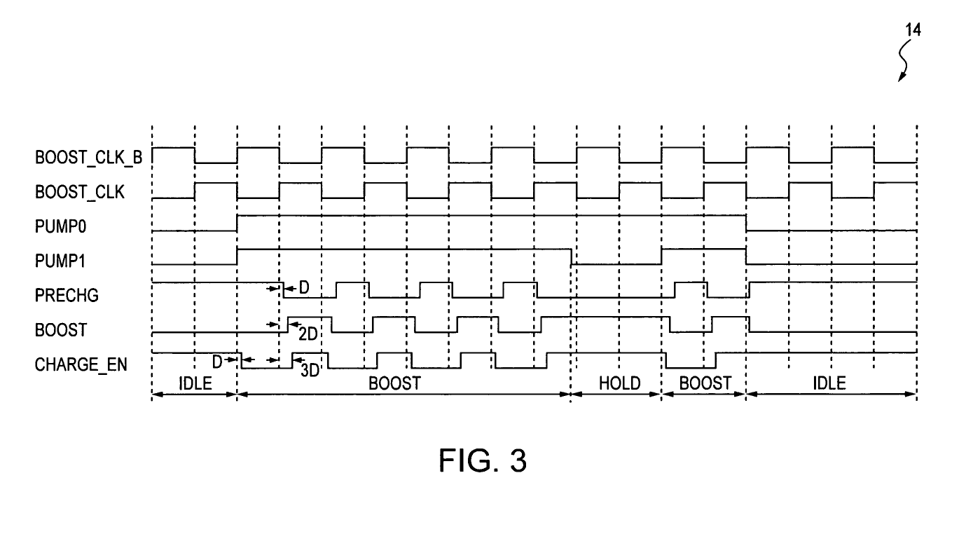

The operation of the control circuit 12 is explained in reference to both FIG. 2 and a timing diagram 14 illustrated in FIG. 3. As explained above, the circuit 10 is in an idle mode when switches sw1a, sw1b, sw3 are closed and switch sw2 is open. This state is maintained when both control signals pump0, pump1 are low, regardless of the state of the clock signal boost_clk or inverse clock signal boost_clk_b. In the logic path 12a for the switch control signal prechrg which includes inverters 27, 28, 29, 30, AND gate 54 and OR gate 44, a low control signal pump0 guarantees that the output of the OR gate 44 is high (because of inverter 28), thus guaranteeing that the switch control signal prechrg is also high. This, in turn, guarantees that the switch control signal boost is low because the AND gate 53 (in the logic path 12b including inverters 25, 26, OR gate 43 and AND gate 53) will always output a low signal when the switch control signal prechrg is high. The switch control signal charge_en is affected by the logic path 12c that includes invertors 21, 22, 23, 24, OR gates 41, 42 and AND gates 51, 52. When both control signals pump0, pump1 are low, the output of AND gate 51 is guaranteed to be high. Thus, switch control signal charge_en is also guaranteed to be high. In this way, the idle mode of circuit 10 is maintained as long as both control signals pump0, pump1 are low.

In order to cause circuit 10 to enter a three-phase boost mode, both control signals pump0, pump1 are raised to a high level. At a point in time coinciding with the falling edge of the clock signal boost_clk, control signals pump0, pump1 are raised to high. This triggers the switch control signal charge_en to go low after a delay D The delay D is caused by hardware or software affecting each logic path 12a, 12b, 12c of the control circuit 12. Also, on the next rising edge of the clock signal boost_clk, the switch control signal prechg is switched to low after a delay D. The change in the switch control signal prechg to low also results in the changing of switch control signal boost to high after yet another delay D. This, in turn, causes the switch control signal charge_en to go high after a delay D.

The falling edge of the clock signal boost_clk results again in the switch control signal charge_en becoming low after a delay D, which triggers the switch control signal boost to also become low after a delay D. The change in the switch control signal boost to low triggers the switch control signal prechg to be made high after a delay D. Then again, at the next rising edge of the clock signal boost_clk, the cycle is repeated with the switch control signal prechg being made low after a delay D, the switch control signal boost being made high after a further delay D, and the switch control signal charge_en being made high after yet another delay D.

The three-phase timing cycle explained above results in a repeated series of precharging, boosting and transferring, which continues as long as both control signals pump0, pump1 are high and the clock signal boost_clk continues to oscillate. Once the output voltage V_hi reaches a desired level as a result of a transfer of charge to capacitor C_load, then control signal pump1 is made low before the next falling edge of the clock signal boost_clk. With control signal pump1 low, the circuit 10 is fixed in a holding mode. With switch control signal prechg being low, switches sw1a, sw1b are open while the high switch control signals boost, charge_en keep switches sw2, sw3 closed. This results in the output voltage V_hi being held while it is sampled. After being held, the circuit may return to normal three-phase operation by making the control signal pump1 high again. Alternatively, the circuit may be discharged to a voltage level Vaa by returning to an idle mode, facilitated by making both control signals pump0, pump1 low.

The three-phase booster circuit 10 and the control circuit 12 are commonly used to boost voltages. Needing only two control signals pump0, pump1 and a clock signal boost_clk to generate the switch control signals charge_en, prechg, boost keeps the circuits 10, 12 simple. The timing of the circuit 10, which must be precise during high-frequency operation, is controlled via the control circuit 12, necessitating very little additional control.

Unfortunately, as operational frequencies increase, the ability of circuit 12 to provide precise control signals to circuit 10 is challenged. The logic devices in circuit 12 and the switches in circuit 10 are limited in their ability to change from a first state to a second state. This limitation, particularly in the switches sw1a, sw1b, sw2, sw3 of circuit 10 can make the circuit 10 impractical to use at high-frequencies. Although the three-phase voltage booster circuit 10 operates reasonably well at operating frequencies of 10 MHz or lower, the circuit 10 is not suited for use at operating frequencies greater than 10 MHz.

The operating rate of the booster circuit 10 is limited to about 10 MHz, as discussed above. However, by configuring two three-phase booster circuits 10 in parallel with each other, the resulting circuit can operate at double the frequency (about 20 MHz) even though the clock signal boost_clk remains at 10 MHz. The resulting circuit is a six-phase voltage booster circuit with a dual conversion rate (i.e., a voltage boost rate arising from two boost circuits) and fully programmable idle and hold modes.

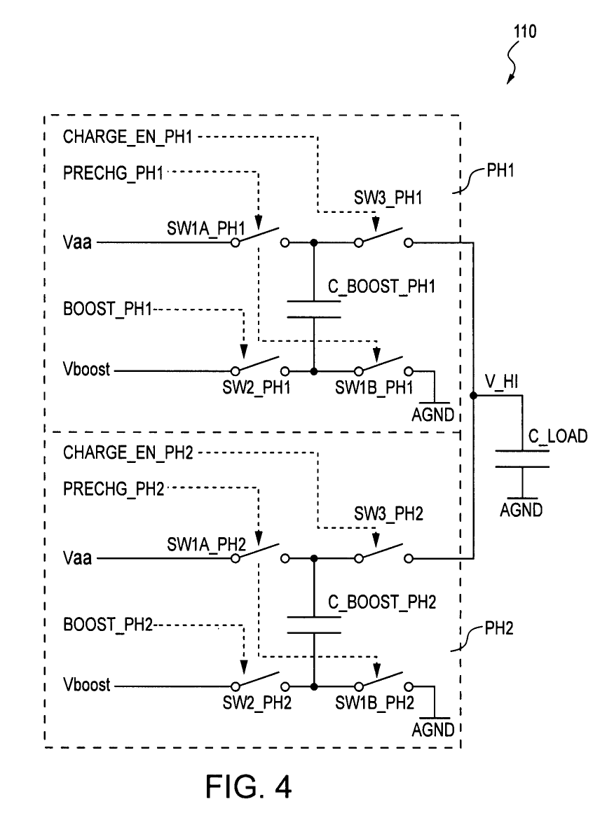

FIG. 4 illustrates a schematic diagram of a six-phase non-overlapping voltage booster circuit 110. The booster circuit 110 is composed of two three-phase booster circuits ph1, ph2. The circuits ph1, ph2 provide a common output voltage V_hi across capacitor C_load. The circuits ph1, ph2 share common voltage inputs Vaa, Vboost. Through the precise timing requirements explained below, voltage Vboost is applied to respective boost capacitors C_boost_ph1, C_boost_ph2 by either circuit ph1, ph2, but never simultaneously. The lack of overlapping loads allows the voltage Vboost to be supplied via an operational amplifier, a regulator or a buffer amplifier.

Generally, each circuit ph1, ph2 operates in the same way as circuit 10 of FIG. 1, as described above. However, because of differences between the timing control circuits that provide the switch control signals for circuits ph1, ph2, the timing of the operation of circuits ph1, ph2 is shifted. In this way, two operations occur in approximately the same amount of time that one operation would require in the circuit 10 of FIG. 1. For example, in approximately the same time that a single boost operation occurs in circuit 10, two boost operations occur in circuit 110. Because each circuit ph1, ph2 operates additively, meaning that the boosted signals from circuits ph1, ph2 are added to each other across capacitor C_load, the output voltage V_hi reaches a maximum level in approximately half the time required for the prior art circuit 10 while still utilizing the same clock signal rate as the circuit 10.

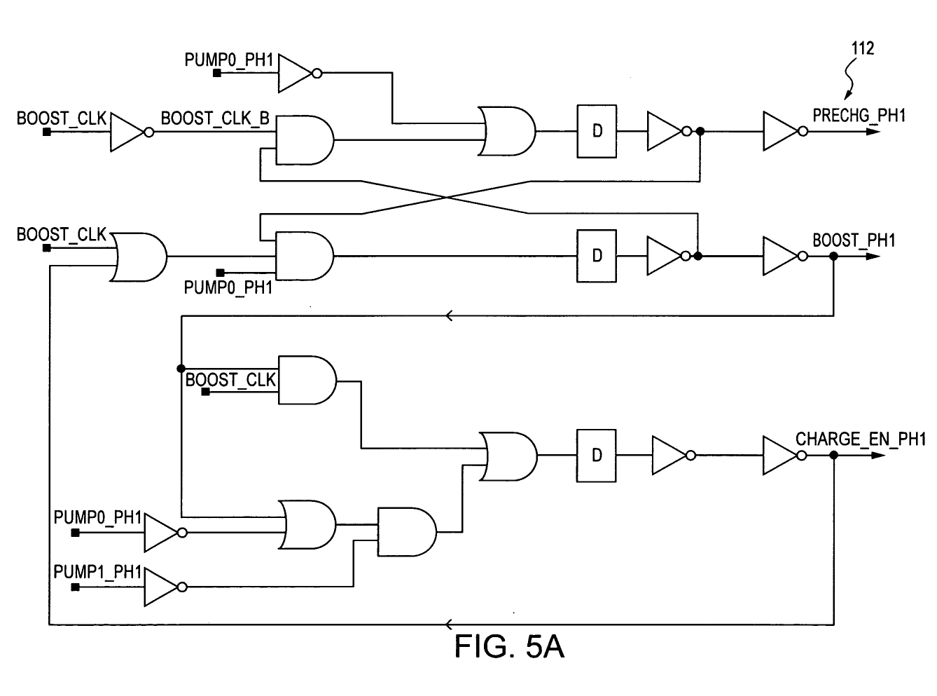

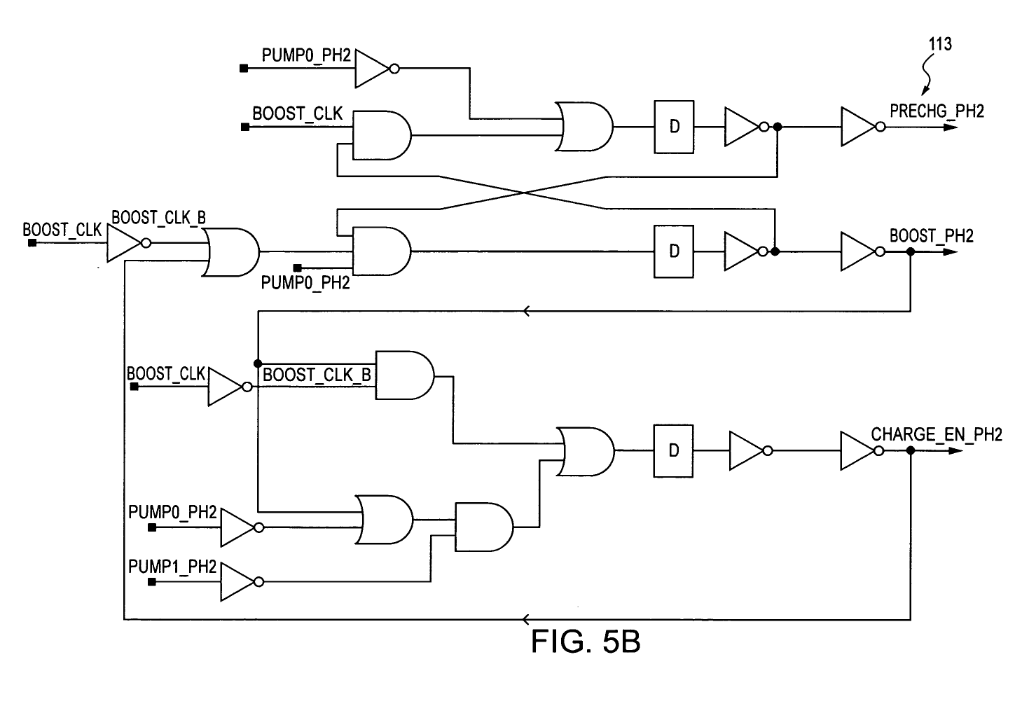

The switch control signals charge_en_ph1, prechg_ph1, boost_ph1 are provided to circuit ph1 via the timing control circuit 112, illustrated in FIG. 5A. Timing control circuit 112 is identical to the control circuit 12 of FIG. 2, except that control circuit 112 uses control signals pump0_ph1, pump1_ph1 and provides switch control signals charge_en_ph1, prechg_ph1, boost_ph1. The switch control signals charge_en_ph2, prechg_ph2, boost_ph2 are provided to circuit ph2 via the timing control circuit 113, illustrated in FIG. 5B. Timing control circuit 113 uses control signals pump0_ph2, pump1_ph2. Timing control circuit 113 also inverts the clock inputs (as compared with control circuits 12, 112). Because control circuits 112, 113 use the same clock input boost_clk, the change in the clock input logic in control circuit 113 results in all switch control signals charge_en_ph2, prechg_ph2, boost_ph2 output by control circuit 113 differing in time with the switch control signals charge_en_ph1, prechg_ph1, boost_ph1 output by control circuit 112 by a half clock cycle of clock signal boost_clk.

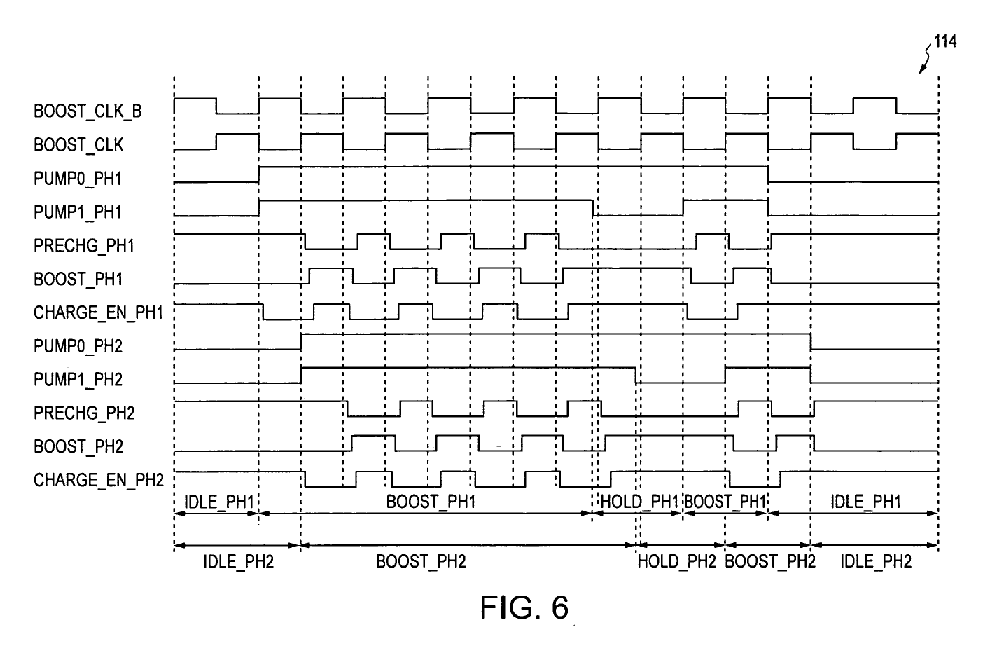

A timing diagram 114 for the control signals pump0_ph1, pump1_ph1, pump0_ph2, pump1_ph2 and associated switch control signals charge_en_ph1, prechg_ph1, boost_ph1, charge_en_ph2, prechg_ph2, boost_ph2 is illustrated in FIG. 6. The top half of diagram 114 showing the clock signal boost_clk and inverse clock signal boost_clk_b, control signals pump0_ph1, pump1_ph1 and switch control signals prechg_ph1, boost_ph1, charge_en_ph1 is identical to the timing pattern illustrated in diagram 14 of FIG. 3. Because the clock inputs are inverted in control circuit 113, however, the bottom half of timing diagram 114 indicates that control signals pump0_ph2, pump1_ph2 and switch control signals prechg_ph2, boost_ph2, charge_en_ph2 are each time-shifted so that switch control signals charge_en_ph2, prechg_ph2, boost_ph2 are generally only active during the time gaps when switch control signals prechg_ph1, boost_ph1, charge_en_ph1 are not active.

As is indicated in FIG. 6, both circuits ph1, ph2 are initially in idle states idle_ph1, idle_ph2, respectively. Circuit ph1 leaves the idle state when control signals pump0_ph1, pump1_ph1 are both made high at a falling edge of clock signal boost_clk. The raising of control signals pump0_ph1, pump1_ph1 triggers circuit ph1 to enter the boost mode boost_ph1. During the boost mode boost_ph1, circuit ph1 cycles through all three phases of precharging, boosting and charge transferring, as explained above with reference to circuit 10. Meanwhile, circuit ph2 exits the idle mode idle_ph2 and begins its own boost mode boost_ph2 a half clock cycle behind circuit ph1. By becoming active exactly one half clock cycle later, the charge transfer phases for both circuits ph1, ph2 do not overlap. The half clock cycle delay also ensures that the circuit ph2 is not still in an idle mode idle_ph2 when circuit ph1 enters a charge transfer phase (during an idle mode, the output voltage V_hi is clamped to the input voltage Vaa, and thus the charge transfer from circuit ph1 would be ineffective if circuit ph2 were still in the idle mode idle_ph2).

Circuit 110 is also able to enter a hold mode when a desired output voltage V_hi is achieved. Circuit ph1 enters the hold mode hold_ph1 when control signal pump1_ph1 is made low. Circuit ph2 enters the hold mode hold_ph2 a half clock cycle later when control signal pump1_ph2 is made low. Because of the delay, the output voltage V_hi during the hold stage is sampled after circuit ph2 has entered the hold mode hold_ph2.

After being in a hold mode, the boost mode is resumed for circuit 110 by first allowing control signal pump_ph1 go high at the negative edge of clock signal boost_clk while still maintaining the circuit ph2 in a hold mode hold_ph2. A half-clock cycle later, circuit ph2 re-enters a boost mode, meaning that the switch control signal charge_en_ph2 is made low before switch control signals boost_ph1, charge_en_ph1 are activated. Thus, there is no overlap between the charge transfer phases of circuits ph1, ph2 during the transition, meaning that the dual boost phases are resumed smoothly.

The dual conversion rate boost operation is terminated by first making control signals pump0_ph1, pump1_ph1 low at a negative edge of clock signal boost_clk. This causes the circuit ph1 to enter the idle mode idle_ph1 wherein the switch control signals precharge_ph1, charge_en_ph1 are made high and the output voltage V_hi is recycled back to Vaa. Additionally recycling of the voltage V_hi occurs when circuit ph2 also re-enters the idle mode idle_ph2. Recycled charge is absorbed by large decoupling capacitors or by other circuits not shown in FIG. 4 but coupled between the voltage input line Vaa and ground.

The dual conversion rate booster circuit 110 which combines two three-phase booster circuits ph1, ph2 is thus able to smoothly transition from an idle mode to a boost mode to a hold mode and back again. The circuits ph1, ph2 are not only configured to operate on complementary clock cycles so as to avoid any overlap between the three phases of the boost mode of circuits ph1, ph2, but the circuits ph1, ph2 are also able to simultaneously operate in both hold and idle modes

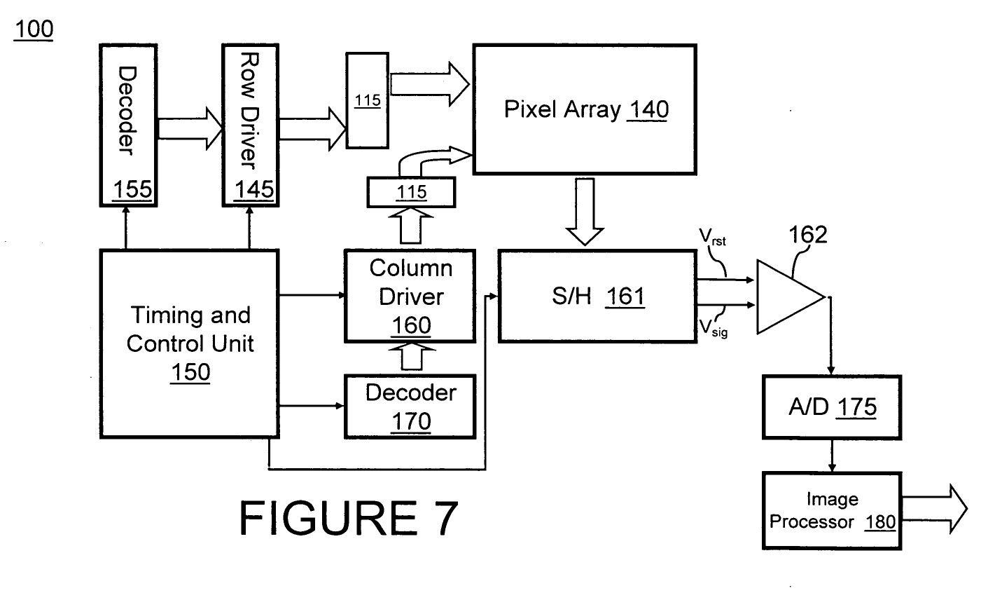

The timing control circuits 112, 113 may be implemented using either hardware or software or via a combination of hardware and software. The circuit 110 and timing control circuits 112, 113 (collectively, the circuit 115) may be used in any electronic circuit and have particular use in an imaging device or other processing system. FIG. 7 illustrates a typical imaging device 100 that incorporates the circuit 115. FIG. 7 illustrates a simplified block diagram of a semiconductor CMOS imager 100 having a pixel array 140 including a plurality of pixel cells arranged in a predetermined number of columns and rows. Each pixel cell is configured to receive incident photons and to convert the incident photons into electrical signals. Pixel cells of pixel array 140 are output row-by-row as activated by a row driver 145 in response to a row address decoder 155. Column driver 160 and column address decoder 170 are also used to selectively activate individual pixel columns. A timing and control circuit 150 controls address decoders 155, 170 for selecting the appropriate row and column lines for pixel readout. The control circuit 150 also controls the row and column driver circuitry 145, 160 such that driving voltages may be applied. The driving voltages are boosted by circuits 115 before being applied to the pixel array 140. Specific driving voltages that are boosted include reset, transfer and row-select voltages as well as photogate charge storing and charge transfer voltages. Other voltages may also be boosted. Although only two circuits 115 are illustrated in FIG. 7, one skilled in the art will understand that multiple circuits 115 may be included, one for each voltage to be boosted. Alternatively, some circuits 115 may be used to selectively output different voltages, as controlled by the timing and control unit 150.

In the imager 100, each pixel cell generally outputs both a pixel reset signal vᵣₛₜ and a pixel image signal v_{sig}, which are read by a sample and hold circuit 161 according to a correlated double sampling (“CDS”) scheme. The pixel reset signal vᵣₛₜ represents a reset state of a pixel cell. The pixel image signal v_{sig} represents the amount of charge generated by the photosensor in the pixel cell in response to applied light during an integration period. The pixel reset and image signals vᵣₛₜ, v_{sig} are sampled, held and amplified by the sample and hold circuit 161. The sample and hold circuit 161 outputs amplified pixel reset and image signals Vᵣₛₜ, V_{sig}. The difference between V_{sig} and Vᵣₛₜ represents the actual pixel cell output with common-mode noise eliminated. The differential signal (e.g., Vᵣₛₜ−V_{sig}) is produced by differential amplifier 162 for each readout pixel cell. The differential signals are digitized by an analog-to-digital converter 175. The analog-to-digital converter 175 supplies the digitized pixel signals to an image processor 180, which forms and outputs a digital image from the pixel values.

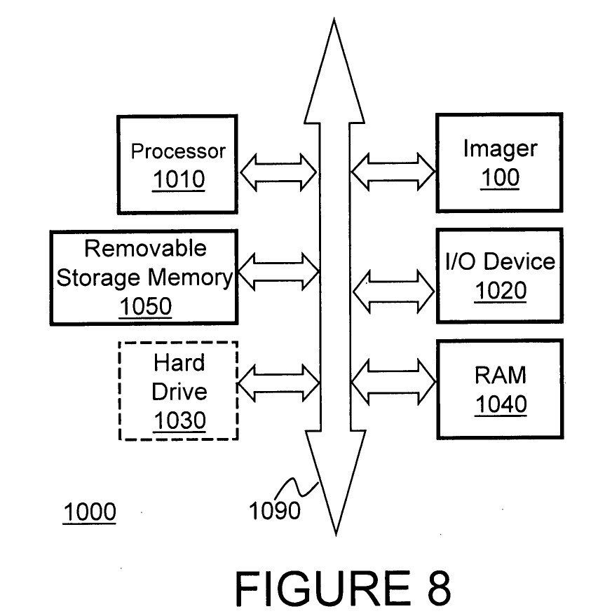

The imager 100 may be used in any system which employs an imager device, including, but not limited to a computer system, camera system, scanner, machine vision, vehicle navigation, video phone, surveillance system, auto focus system, star tracker system, motion detection system, image stabilization system, and other imaging systems. Example digital camera systems in which the invention may be used include both still and video digital cameras, cell-phone cameras, handheld personal digital assistant (PDA) cameras, and other types of cameras. FIG. 8 shows a typical processor system 1000 which is part of a digital camera 1001. The processor system 1000 includes an imaging device 100 which includes one or more circuits 115, in accordance with the embodiments described above. System 1000 generally comprises a processing unit 1010, such as a microprocessor, that controls system functions and which communicates with an input/output (I/O) device 1020 over a bus 1090. Imaging device 100 also communicates with the processing unit 1010 over the bus 1090. The processor system 1000 also includes random access memory (RAM) 1040, and can include removable storage memory 1050, such as flash memory, which also communicates with the processing unit 1010 over the bus 1090. Lens 1095 focuses an image on a pixel array of the imaging device 100 when shutter release button 1099 is pressed.

The processor system 1000 could alternatively be part of a larger processing system, such as a computer. Through the bus 1090, the processor system 1000 illustratively communicates with other computer components, including but not limited to, a hard drive 1030 and one or more removable storage memory 1050. The imaging device 100 may be combined with a processor, such as a central processing unit, digital signal processor, or microprocessor, with or without memory storage on a single integrated circuit or on a different chip than the processor.

Although emphasis has been placed on using the circuit 115 in an imaging device, one skilled in the art will recognize that the circuit 115 may be used in any system wherein voltage boosting is required (e.g., memories, etc.).

1. A circuit, comprising:
a first voltage boosting circuit for supplying a first boosted voltage in response to a first set of control signals;
a second voltage boosting circuit for supplying a second boosted voltage in response to a second set of control signals;
a load terminal for receiving and combining said first and second boosted voltages; and
a control circuit responsive to a boost clock signal for supplying said first and second sets of control signals to said first and second voltage boosting circuits so that said first and second boosted voltages are alternately transferred to said load terminal.

2. The circuit of claim 1, wherein the first and second voltage boosting circuits are placed in an idle mode by clamping the load terminal to a reference voltage.

3. The circuit of claim 1, wherein the first and second voltage boosting circuits are placed in a hold mode when the load terminal is simultaneously coupled to both the first and second voltage boosting circuits.

4. The circuit of claim 1, wherein the first set of control signals includes a first precharge signal, a first boost signal, and a first charge transfer signal, and the second set of control signals including a second precharge signal, a second boost signal, and a second charge transfer signal, the first and second precharge signals being offset from each other, the first and second boost signals being offset from each other, and the first and second charge transfer signals being offset from each other.

5. The circuit of claim 4, wherein the first voltage boosting circuit is precharged to a first precharge voltage when the first precharge signal is active and the first boost signal and first charge transfer signal are not active, while the second voltage boosting circuit is precharged to a second precharge voltage when the second precharge signal is active and the second boost signal and second charge transfer signal are not active.

6. The circuit of claim 5, wherein the first precharge voltage is boosted to the first boosted voltage by a boost voltage coupled to the first voltage boosting circuit when the first boost signal is active and the first precharge signal is not active, while the second precharge voltage is boosted to the second boosted voltage by the boost voltage couple to the second voltage boosting circuit when the second boost signal is active and the second precharge signal is not active.

7. The circuit of claim 6, wherein the first boosted voltage is transferred to the load terminal when the first charge transfer signal is active and the first precharge signal is not active, while the second boosted voltage is transferred to the load terminal when the second charge transfer signal is active and the second precharge signal is not active.

8. The circuit of claim 1, wherein the control circuit activates the second set of control signals a half boost clock signal cycle after the control circuit activates the first set of control signals.

9. (canceled)

10. An imager, comprising:
a pixel array; and
at least one voltage boosting circuit for supplying boosted voltages to the pixel array, the at least one voltage boosting circuit comprising:
a switch control circuit for providing switch control signals; and
a six-phase voltage booster circuit that operates in response to the switch control signals.

11. The imager of claim 10, wherein the six-phase voltage booster circuit comprises:
a first three-phase voltage boosting circuit that operates in a first precharge phase, a first boosting phase and a first charge transfer phase;
a second three-phase voltage boosting circuit that operates in a second precharge phase, a second boosting phase and a second charge transfer phase; and
a load terminal for alternately receiving and combining charge generated by the first three-phase voltage boosting circuit and the second three-phase voltage boosting circuit.

12-14. (canceled)

15. The imager of claim 14, wherein during six-phase operation, the first precharge phase, the first boosting phase, and the first charge transfer phase each occur a half clock-cycle before the second precharge phase, the second boosting phase, and the second charge transfer phase, respectively.

16. A processing system, comprising:
a processor; and
an imaging device coupled to said processor, said imaging device comprising:
a pixel array that inputs boosted voltages; and
one or more circuits that each comprise:
a first voltage boosting circuit for supplying a first boosted voltage in response to a first set of control signals;
a second voltage boosting circuit for supplying a second boosted voltage in response to a second set of control signals;
a load terminal for receiving and adding said first and second boosted voltages; and
a control circuit responsive to a boost clock signal for supplying said first and second sets of control signals to said first and second voltage boosting circuits so that said first and second boosted voltages are alternately transferred to said load terminal.

17. The system of claim 16, wherein the control circuit activates the second set of control signals a portion of a boost clock signal cycle after the control circuit activates the first set of control signals.

18. The system of claim 17, wherein the portion of a boost clock signal cycle is a half boost clock signal cycle.

19. The system of claim 17, wherein the first set of control signals includes a first precharge signal, a first boost signal and a first charge transfer signal, and the second set of control signals includes a second precharge signal, a second boost signal and a second charge transfer signal.

20-21. (canceled)

22. A method of boosting a voltage, the method comprising:
precharging first and second charge storing circuits to a first and second precharge voltage, respectively;
boosting the first and second precharge voltages to a first and second boost voltage, respectively; and
alternately and additively transferring the first and second boost voltages from the first and the second charge storing circuits to a load terminal.

23. The method of claim 22, further comprising repeating the precharging, boosting and transferring steps until a desired voltage is present at the load terminal.

24. The method of claim 22, wherein the first and the second charge storing circuits are precharged at different times and are boosted at different times.

25. The method of claim 22, further comprising placing the load terminal in an idle mode by clamping the load terminal to a precharge voltage source.

26. The method of claim 22, further comprising placing the load terminal in a hold mode by simultaneously receiving the first and second boost voltages at the load terminal from the first and second charge storing circuits.

27. A method of boosting a voltage using a first and second voltage boosting circuit, a load terminal and a control circuit, the method comprising:
supplying a first precharge signal by the control circuit to the first voltage boosting circuit in order to charge the first voltage boosting circuit;
supplying a first boost signal by the control circuit to the first voltage boosting circuit in order to boost the charge in the first voltage boosting circuit;
supplying a first charge transfer signal by the control circuit to the first voltage boosting circuit in order to transfer the boosted charge from the first voltage boosting circuit to the load terminal;
supplying a second precharge signal by the control circuit to the second voltage boosting circuit in order to charge the second voltage boosting circuit;
supplying a second boost signal by the control circuit to the second voltage boosting circuit in order to boost the charge in the second voltage boosting circuit; and
supplying a second charge transfer signal by the control circuit to the second voltage boosting circuit in order to transfer the boosted charge from the second voltage boosting circuit to the load terminal at a different time than when the boosted charge from the first voltage boosting circuit is transferred to the load terminal.

28. The method of claim 27, wherein the second precharge signal is offset from the first precharge signal, the second boost signal is offset from the first boost signal, and the second charge transfer signal is offset from the first charge transfer signal.

29. The method of claim 28, wherein the offset between signals is a half clock cycle.

30. The method of claim 27, wherein the first precharge signal and the first charge transfer signal are each supplied at a same time in order to place the first voltage boosting circuit in an idle mode, and the second precharge signal and the second charge transfer signal are each supplied at a same time in order to place the second voltage boosting circuit in an idle mode.

31. The method of claim 27, wherein the first and second charge transfer signals are each supplied at a same time while the first and second precharge signals are not supplied in order to place the first and second voltage boosting circuits in a hold mode.
